(19) United States
(12) Patent Application Publication
(10) Pub. No.: US 2024/0123638 A1
(43) Pub. Date: Apr. 18, 2024

(54) GUARD FOR HAIR CLIPPERS

(71) Applicant: Eazy Clipz, LLC, Peoria, AZ (US)

(72) Inventor: Arturo Perez, Peoria, AZ (US)

(73) Assignee: Eazy Clipz, LLC, Peoria, AZ (US)

(21) Appl. No.: 17/966,518

(22) Filed: Oct. 14, 2022

(51) Int. Cl. B26B 19/38; B26B 19/20

(52) U.S. Cl. CPC B26B 19/3813; B26B 19/20

(57) ABSTRACT

A guard for a hair clipper includes a body having a comb and a retention wall disposed at a distal end of the body opposite the comb. The comb defines a cutaway. A first tab extends from the body and partially defines an opening through the body. The first tab includes a first notch oriented towards the opening. A second tab extends from the body and partially defines the opening through the body. The second tab includes a second notch oriented towards the first notch. A magnet is disposed in the opening and includes a cuboid geometry. The magnet defines a first channel in a first surface and a second channel in a second surface opposite the first surface. The first notch engages the first channel, and the second notch engages the second channel.

### FIELD

The present disclosure relates to hair clippers and, more specifically, to a universal guard for hair clippers.

### BACKGROUND

Hair clippers typically come with guards that specifically mate with a particular clipper. Barbers may have several clippers at their station for different purposes, and each clipper has its own guards. Managing the host of different guards results in a cluttered cutting station.

Hair professionals also operate with hands holding combs, scissors, and other tools that result in full hands. They may attach and remove guards to a clipper using only one hand through the course of a cut. Traditional guards are unstable in some orientations. Guards can be prone to flipping in response to attempts to press the guard onto the clipper with one hand.

### SUMMARY

In various embodiments, a universal guard includes a magnet for engagement with a hair clipper. A universal guard may include a body having a comb and a retention wall disposed at a distal end of the body opposite the comb. The comb defines a cutaway. A first tab extends from the body and partially defines an opening through the body. The first tab includes a first notch oriented towards the opening. A second tab extends from the body and partially defines the opening through the body. The second tab includes a second notch oriented towards the first notch. A magnet is disposed in the opening and includes a cuboid geometry. The magnet defines a first channel in a first surface and a second channel in a second surface opposite the first surface. The first notch engages the first channel, and the second notch engages the second channel A lip extends from the body and partially defines the opening. The lip engages a third surface of the magnet. The magnet is flush with a surface of the lip.

Various guards include a body with a comb and a retention wall disposed at a distal end opposite the comb. The comb defines a cutaway, and the body defines an opening. A magnet retained in the opening. A retention tab extends from the body adjacent the opening and includes a notch to engage the magnet. The magnet defines a channel to receive the notch. A lip extends from the body adjacent the opening. The lip has surface configured to engage a head of a clipper. The magnet is substantially parallel to the surface of the lip. A retention step extends from the body and the retention wall. The magnet is a rare earth magnet. Wings extending from the body to resist rotation.

Some guards include a body comprising a comb and a retention wall disposed at a distal end opposite the comb. The comb defines a cutaway. A retention tab extends from the body and partially defines an opening that extends through the body. A magnet is disposed in the opening and retained by the retention tab. The retention tab includes a notch to engage the magnet. The magnet comprises a channel to receive the notch. A lip extends from the body adjacent the opening. The magnet is substantially parallel to a surface of the lip. A retention step extending from the body and the retention wall. The magnet is a rare earth magnet. A second tab extends from the body and partially defines the opening. The first tab engages the first channel defined in the magnet, and wherein the second tab engages a second channel defined in the magnet.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates an elevation view from the side of a universal guard for clippers, in accordance with various embodiments;

FIG. 2 illustrates a top view of a universal guard, in accordance with various embodiments;

FIG. 3 illustrates a top perspective view of a universal guard, in accordance with various embodiments;

FIG. 4 illustrates a bottom perspective view of a universal guard, in accordance with various embodiments;

FIG. 5 illustrates a perspective view of a magnet for coupling to a universal guard, in accordance with various embodiments;

FIG. 6 illustrates an exploded view of a universal guard and magnet, in accordance with various embodiments; and

FIG. 7 illustrates a perspective view of a universal guard installed on a clipper, in accordance with various embodiments.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the inventions, other embodiments may be realized, and that logical, chemical, and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The present disclosure is directed to a guard for electronic hair clippers. The guard is configured to generally improves the hair professional's experience in storing and using the guard. Guards of the present disclosure may include features to that tend to support fitment on various different clippers from various different manufacturers. Guards of the present disclosure may also tend to resist lateral rotation and movement in response to one-handed mounting attempts.

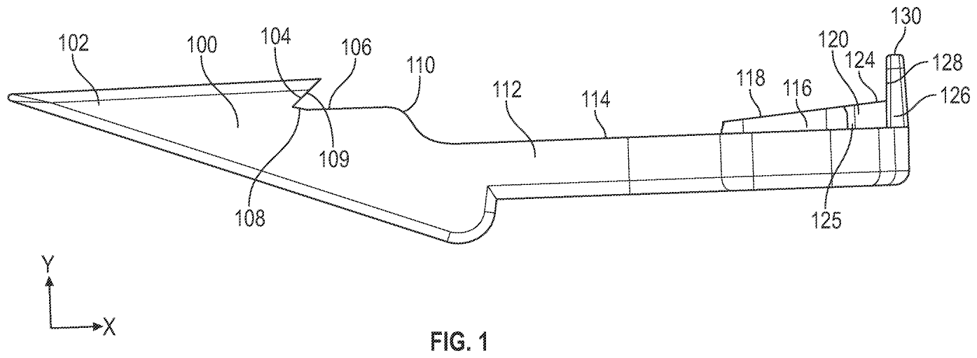

With reference to FIG. 1, universal guard 100 is shown, in accordance with various embodiments. Guard 100 comprises comb 102 having several triangular teeth. The teeth of comb 102 have height in the y direction corresponding to traditional guard sizes (e.g., number 0, 1, 2, 3, 4, 5, 6, 7, 8, 10, 12), nontraditional guard sizes (e.g., 1/125 in, 1/50 in, 3/64 in, 3/32 in, ⅛ in, 5/31 in, ¼ in, ⅜ in, ½ in, ⅝ in, etc.) or any other suitable sizes correlating to a desired hair length resulting from use of a selected guard. Comb 102 has cutaway 104 defined by edge 109 and edge 108 of comb 102 meeting at an acute angle. Cutaway 104 may comprise a v-shaped profile. The triangular teeth may each define cutaway 104. Teeth on the outer edges of comb 104 may have varied profiles from internal teeth to retain a clipper against guard 100. In that regard, the inner surfaces of the outer teeth of comb 104 may engage the sides of a clipper coupled to guard 100.

In various embodiments, the angle between edge 109 and edge 108 of comb 102 may be, for example, approximately 40 degrees, 45 degrees, 50 degrees, 55 degrees, 60 degrees, 65 degrees, 70 degrees, 75 degrees, or 80 degrees. The term “approximately” as used herein to describe lengths or angles may mean+/−5%, +/−10%, +/−15%, or +/−20%.

In various embodiments, edge 108 may also meet edge 106 of comb 102 at an obtuse angle such that edge 106 and edge 108 appear nearly parallel to the naked eye. The angle between edge 106 and edge 108 of comb 102 may be, for example, approximately 175 degrees, 170 degrees, 165 degrees, 160 degrees, or 155 degrees. Edge 108 and edge 106 may be parallel and form a single continuous flat edge in some embodiments.

In various embodiments, edge 106 may transition tangentially into rounded edge 110 of body 112 having an s-shaped profile with an aft segment of edge 110 transitioning tangentially into surface 114 of body 112. Body 112 comprises various features to facilitate removable coupling of guard 100 to a clipper. Body comprises lip 116 having a sloped profile with the height of lip 116 above body 112 tending to be taller in the y direction at a location nearest retention wall 126 and shorter in the y direction at a location nearest comb 102. In that regard, surface 118 of lip 116 may be sloped relative to body 112. Lip 112 may support a clipper engaged with guard 100 in the y direction. Lip 112 may also engage and retain a magnet that pulls against a clipper engaged with guard 100.

In various embodiments, retention step 120 protrudes from body 112 in the y direction from a side opposite comb 102. Retention step 120 comprises support surface 124 substantially parallel to lip 116 and surface 114 of body 112. When viewed from the side, support surface 124 appears to extend surface 118 of lip 116 in some embodiments. Support surface 124 of retention step 120 can support clippers engaged with guard 100 in the y direction. Body 112 is typically made of plastic, though other rigid materials may be used in various embodiments.

In various embodiments, retention wall 126 extends in the y direction from body 112 with an outer surface facing away from retention step 120 in the x direction. The outer surface of retention wall 126 faces towards the rear of guard 100 away from opposite comb 102. In that regard, retention wall 126 may be disposed at a distal end of guard 100 opposite comb 102. Retention wall 126 includes upper retention face 128 extending away from surface support surface 124 in the y direction. Retention face 128 may engage a clipper coupled to guard 100 and inhibit the clipper head from sliding past retention wall 126 in the x direction. Upper surface 130 of retention wall 126 may extend in the x direction and may terminate at the distal end of guard 100.

In various embodiments, the foregoing features of guard 100 tend to retain the head of a clipper. Blades of a clipper may engage comb 102 along edge 109, edge 108, and/or edge 106 defining cutaway 104. Guard 100 tends to retain blades in cutaway 104 of comb 102. The heel of clippers (e.g., the end of the head opposite the blades) may variously engage features at the rear of guard 100 opposite comb 102. A magnet may protrude from lip 116, be flush with lip 116, or recede beneath lip 116 in the y direction into an opening defined in body 112. The magnet engages a metal clipper head or screw to improve retention forces between guard 100 with a clipper.

In various embodiments, different clippers may have different sized heads that engage guard 100 in different ways. For example, the heel of a clipper may rest on body 112, lip 116, and retention step 120. The heel and blades of a clipper would thus tend to engage surfaces defining cutaway 104 and front edge of retention step 120 to maintain the clipper position relative to guard 100 in the x direction.

In another example contemplating a longer clipper head in the x direction, the heel of a clipper may rest on support surface 124 and engage upper retention face 128. The heel and blades of a clipper would thus tend to engage surfaces defining cutaway 104 and upper retention face 128 to maintain the clipper position relative to guard 100 in the x direction.

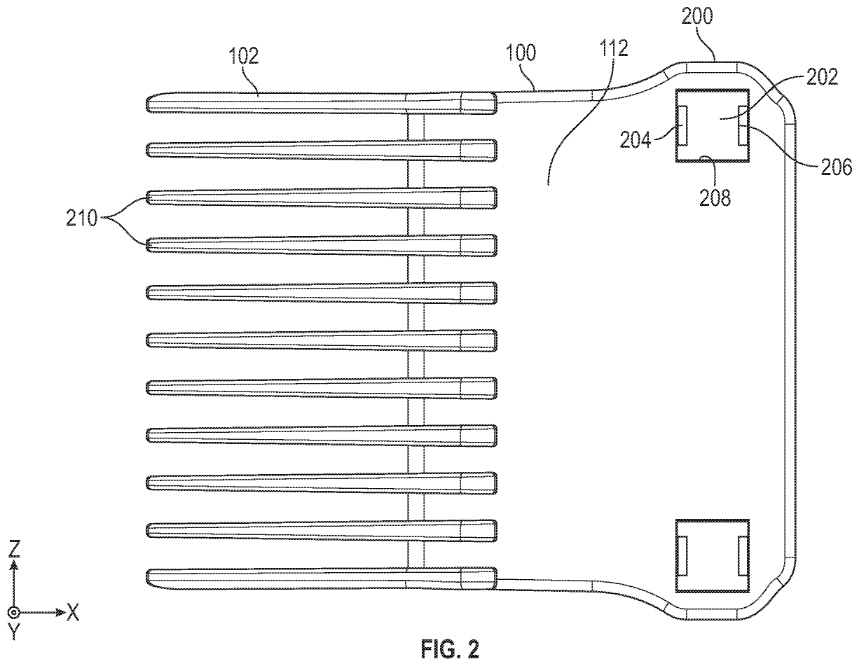

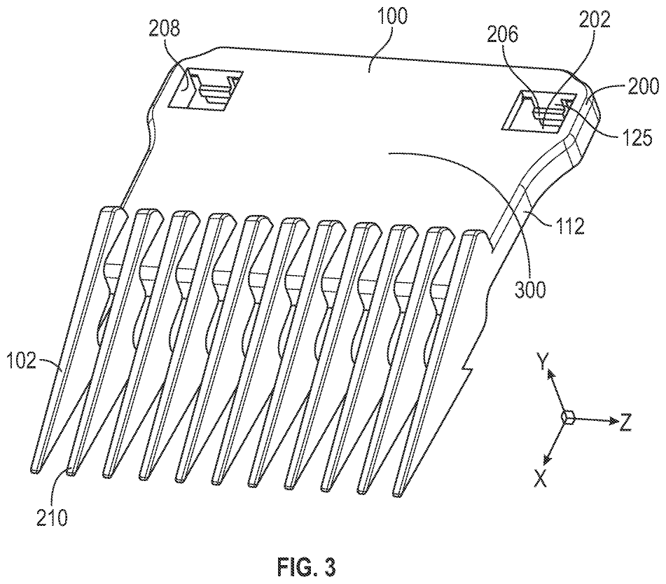

Referring now to FIGS. 2 and 3, guard 100 is shown defining openings 202 for receiving magnets, in accordance with various embodiments. Comb 102 comprises teeth 210 extending away from body 112 in the x direction. Teeth may be spaced from one another in the z direction at any desired interval, though many embodiments use uniform spacing between teeth 210 of comb 102. The side surface of body 112 may be substantially parallel to side surfaces of the outermost teeth 210. Comb 102 guides hair onto blades of a clipper attached to guard 100.

In various embodiments, wings may protrude from the sides of body 112 in the z direction. In that regard, body 112 may be wider at the end opposite comb 102 in the x direction. Outer surface 300 of body 112 may be at its widest point in the z direction as the surface extends outwards into wings 200. Wings 200 tend to stabilize guard 100 during attachment to clippers. For example, wings 200 and surface 300 may lay near a work surface and oppose rotation about the x axis in response to a clipper pressing towards the work surface and into guard 100. In that regard, wings 200 tend to stabilize guard 100 against rotation or other unwanted movement when driving guard 100 against a table or worktop.

In various embodiments, body 112 comprises openings 202 defined by sidewalls 208, notch 204, notch 206, and tabs 125. Sidewalls 208 may be oriented in a rectangular arrangement such that opening 202 has a square profile. Retention tabs 125 extend from body 112 and define a boundary of openings 202. Notches 204 and 406 extend from retention tabs 125 and engage a channel in a magnet to retain the magnet in openings 200. Openings 202 may be disposed through body 112 adjacent wings 200 of body 112. Openings 202 extend through body 112 in the y direction and are located at opposite sides of body 112 in the z direction.

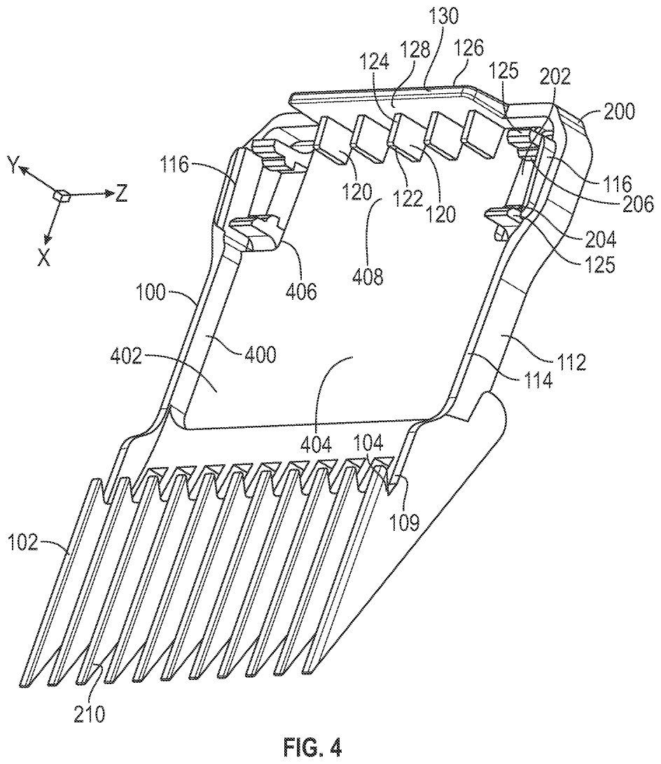

Referring now to FIG. 4, a perspective view depicting the bottom of guard 100 is shown, in accordance with various embodiments. Lip 116 defines an end of openings 202 through body 112. Recessed surface 402 and inner walls 400 define cavity 404 in body 112 of guard 100. Tapered inner walls 406 and inner surface 404 may define a narrowed portion of cavity 404. Cavity 404 may receive various parts of different clipper models in engagement with a clipper removably coupled to guard 100.

In various embodiments, guard 100 includes retention steps 120 arranged in substantially parallel to one another. The retention face 122 of retention steps 120 faces toward comb 102. Retention faces 122 may engage rear-facing surfaces of a clipper engaged with guard 100 to inhibit rearward motion of the clipper head in the x direction. In that regard, retention faces 122 and retention face 128 may variously engage different clipper heads to facilitate broad compatibility between guard 100 and a variety of clippers. Various clipper heads may be pressed into guard 100 along the y axis with blades of a clipper engaging cutout 104 and the heel of the clipper engaging retention face 122 or retention step 128.

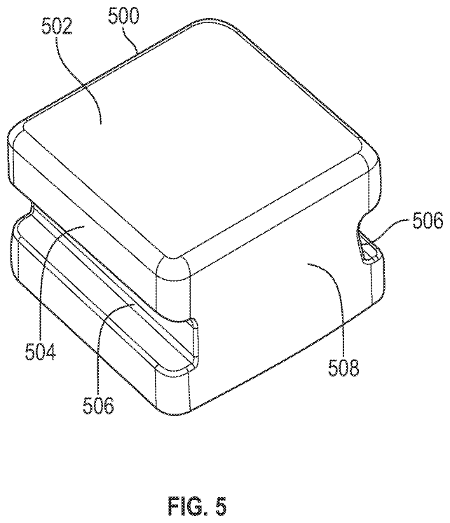

Referring now to FIG. 5, a magnet 500 is shown, in accordance with various embodiments. Magnet 500 may generally have a cuboid shape configured to mate with body 112 (of FIG. 1) in opening 202 (of FIGS. 2, 3, and 4). In that regard, opening 202 and magnet 500 may comprise different profile shapes to facilitate retention of magnet 500 within opening. Examples of profile shapes include triangular, trapezoidal, rectangular, circular, irregular, or other suitable profile shapes. Magnet 500 may be a rare earth magnet or other form of permanent magnet for ease of use. Temporary magnets or electromagnets may also be used in other embodiments.

With continuing reference to FIG. 5 and renewed reference to FIG. 4, magnet 500 includes outer surface 502. Outer surface 502 is substantially smooth and may be exposed from body 112 in response to insertion into opening 202. Side surface 508 of magnet 500 may include a smooth surface configured to engage sidewall 208 that at least partially defines opening 202 and has a smooth surface. Side surface 508 of magnet 500 may slidably engage sidewalls 208 in response to magnet 500 being coupled to body 112. Magnet 500 may thus be mechanically coupled to body 112. Magnet 500 may comprise sidewalls 504 defining cavities 506. Cavities 506 may be disposed on opposite sides of magnet 500. Cavities 506 may be configured to receive notch 204 and notch 206 of opposing retention tabs 125. Notches may fit into cavities 506 to retain magnet 500 in opening 202. In that regard, retention tabs 125 retain magnet 500 in opening 202.

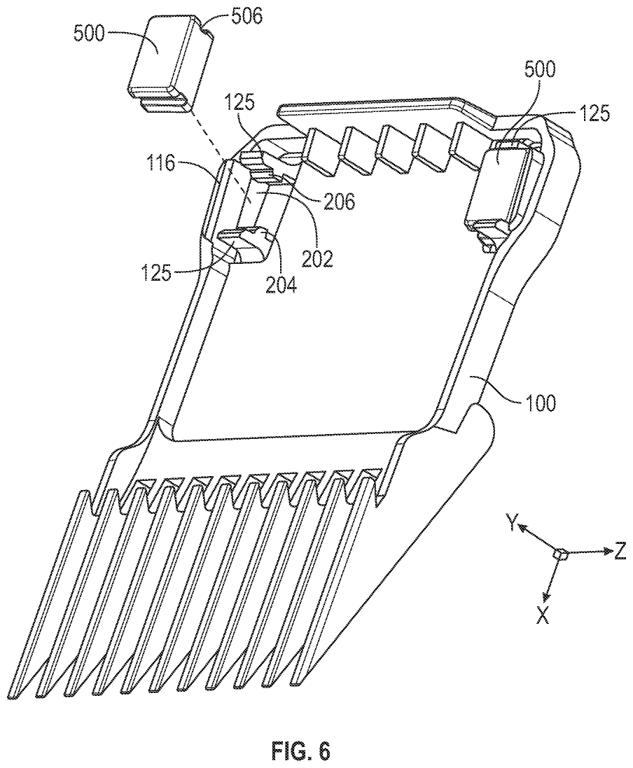

Referring now to FIG. 6, a perspective view of guard 100 is shown with one magnet 500 exploded out of a first opening 202 and a second magnet retained in a second opening 202, in accordance with various embodiments. Magnet 500 may be retained in body 212 flush, protruding, or recessed relative to the outer surfaces of guard 100. In the example of FIG. 6, surface 502 of magnet 500 is exposed from opening 202 and substantially flush with lip 116 in response to being snapped into tabs 125.

In various embodiments, notches 204 and 206 may be substantially the same size as channels 506 to reduce movement of magnet in the y direction. Notches 204 and 206 may also be smaller than channels 506 to allow movement of magnet 500 in the y direction. Reduced movement may tend to hold guard 100 more stable against a clipper. Allowing greater movement tends to allow magnet to translate within opening and contact or move closer to a clipper head, which increases the pulling force exerted by magnet 500 on the clipper head.

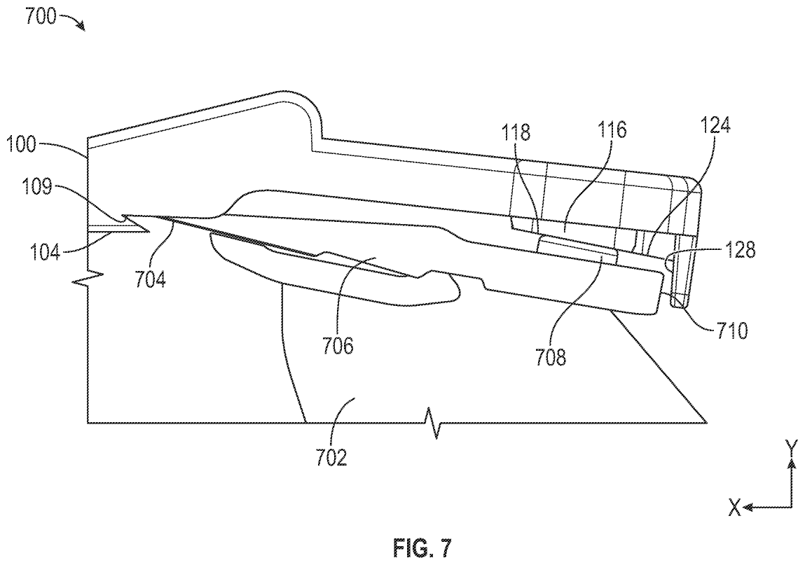

With reference to FIG. 7, guard 100 is shown engaging a head 706 of clipper 702, in accordance with various embodiments. The tip of tabs 125, surface 118 of lip 116, surface 502 of magnet 500, and support surface 124 of retention steps 120 may be substantially coplanar to receive a clipper at various locations. In the example of FIG. 7, screw 708 protruding from head 706 rests against surface 118 of lip 116. Magnet 500 (of FIG. 6) is flush with lip 118 and may contact screw 708 or head 706. Screw 708 or head 706 may be ferrous metal or other magnetic material to magnetically engage magnet 500.

In various embodiments, magnetic retention forces exerted on clipper 702 by magnets 500 tend to hold clipper 702 in place relative to guard 100. Blade 704 of clipper 702 may engage cutout 704 to retain guard 704 in place. Blade 704 retained in cutout 104 tends to have the desired height from a clients head during a haircut to cut hair to a predetermined length. Retention face 128 may engage rear surface 710 of clipper 702. Retention surface 128 tends to inhibit head 706 from slipping past the end of guard 100 in an x direction.

Guards as described herein tend to securely fit onto clipper heads 706 of various sizes and shapes. Magnetic force tends to pull the guard and clipper head towards one another. The cutaway simultaneously holds blades of the clipper head in place during use. As a result, guards of the present disclosure tend to be compatible with a variety of clippers. Guards of the present disclosure may also include wings and magnets that tend to make coupling guard to clipper easier.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A guard for a hair clipper, comprising:
a body including a comb and a retention wall disposed at a distal end opposite the comb, wherein the comb defines a cutaway;
an opening defined by the body; and
a magnet retained in the opening.

2. The guard of claim 1, further comprising a retention tab extending from the body adjacent the opening.

3. The guard of claim 2, wherein the retention tab includes a notch to engage the magnet.

4. The guard of claim 3, wherein the magnet defines a channel to receive the notch.

5. The guard of claim 1, further comprising a lip extending from the body adjacent the opening, the lip having surface configured to engage a head of a clipper.

6. The guard of claim 5, wherein the magnet is substantially parallel to the surface of the lip.

7. The guard of claim 1, further comprising a retention step extending from the body and the retention wall.

8. The guard of claim 1, wherein the magnet is a rare earth magnet.

9. The guard of claim 1, further comprising wings extending from the body to resist rotation.

10. A guard for a hair clipper, comprising:
a body including a comb and a retention wall disposed at a distal end opposite the comb, wherein the comb defines a cutaway;
a retention tab extending from the body and partially defining an opening that extends through the body; and
a magnet disposed in the opening and retained by the retention tab.

11. The guard of claim 10, wherein the retention tab includes a notch to engage the magnet.

12. The guard of claim 11, wherein the magnet defines a channel to receive the notch.

13. The guard of claim 10, further comprising a lip extending from the body adjacent the opening.

14. The guard of claim 13, wherein the magnet is substantially parallel to a surface of the lip.

15. The guard of claim 10, further comprising a retention step extending from the body and the retention wall.

16. The guard of claim 10, wherein the magnet is a rare earth magnet.

17. The guard of claim 10, further comprising a second tab extending from the body and partially defining the opening, wherein the first tab engages the first channel defined in the magnet, and wherein the second tab engages a second channel defined in the magnet.

18. A guard for a hair clipper, comprising:
a body including a comb and a retention wall disposed at a distal end of the body opposite the comb, wherein the comb defines a cutaway;
a first tab extending from the body and partially defining an opening through the body, wherein the first tab includes a first notch oriented towards the opening;
a second tab extending from the body and partially defining the opening through the body, wherein the second tab includes a second notch oriented towards the first notch; and
a magnet disposed in the opening and comprising a cuboid geometry, the magnet defining a first channel in a first surface and a second channel in a second surface opposite the first surface, wherein the first notch engages the first channel and the second notch engages the second channel.

19. The guard of claim 18, further comprising a lip extending from the body and partially defining the opening, wherein the lip engages a third surface of the magnet.

20. The guard of claim 18, wherein the magnet is flush with a surface of the lip.
